(19) United States
(12) Patent Application Publication
(10) Pub. No.: US 2009/0172777 A1
(43) Pub. Date: Jul. 2, 2009

(54) SYSTEM AND METHOD FOR TRACKING DOCUMENTS

(75) Inventors: Gary G. Hansen, Newtown, CT (US); Arthur J. Parkos, Southbury, CT (US); Jean-Hiram Coffy, Norwalk, CT (US); Luis A. Sanchez, Troy, NY (US); Claude Zeller, Shelton, CT (US); Ronald Reichman, Trumbull, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 11/968,151

(22) Filed: Dec. 31, 2007

(51) Int. Cl. H04L 9/32

(52) U.S. Cl. 726/2

(57) ABSTRACT

Systems and methods for tracking documents are described. In certain examples, systems and methods for authenticating and tracking physical documents through a multiple party work flow across a geographically dispersed area using digital pens and RFID tags are described.

### FIELD OF THE INVENTION

The illustrative embodiments described in the present application are useful in systems including those for tracking documents and more particularly are useful in systems including those for authenticating and tracking physical documents through a multiple party work flow across a geographically dispersed area.

### BACKGROUND

There are many workflow software systems that automate workflow processes such as in a customer service department of an organization or a college administration organization. For example, the CAPTARIS WORFLOW system is available from Captaris, Inc. of Bellevue, Wash. and the TOTAL CAMPUS MANANGEMENT system is available from Jenzabar, Inc. of Boston, Mass.

For example, when a prospective college student contemplates filing multiple college applications, there are many challenges that the student will face. For example, there are several documents that must be procured from multiple sources and sent to each college. For example, the student will typically be required to request a high school transcript for each college application and typically must have an official copy sent directly from the high school to the particular college. However, the student has no way of knowing whether the high school complied with the transcript requests and when the transcripts may have been sent. Furthermore, students are often anxious because they do not know when each particular transcript is received by each particular college and because the student does not have visibility into the processing of his transcript within the college. Therefore, students may make time consuming calls into each school requesting status.

Furthermore, the high school may apply its particular embossed seal, but there is no standardized automated method for authenticating the transcripts sent to the college from many different high schools.

### SUMMARY

The present application describes illustrative embodiments of systems and methods for tracking documents and in certain embodiments for authenticating and tracking physical documents through a multiple party work flow across a geographically dispersed area.

In one illustrative example, a system for tracking a document through a physical delivery channel and an internal work flow process is described. The document is also authenticated using a digital pen authentication system by first authenticating a source of the document and then authenticating at least one stage of processing at a remote service provider location.

In another illustrative example, a central authority tracks and authenticates a plurality of document groups, each having an associated plurality of physical documents in a portfolio for a user.

In yet another illustrative embodiment, an authentication and tracking tag is provided wherein a wireless tag data storage location includes at least part of an identifier associated with a digital pen pattern attached to the wireless tag.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic functional block diagram of a system for authenticating and tracking physical documents through a multiple party work flow across a geographically dispersed area according to an illustrative embodiment of the present application.

FIG. 2 is a schematic functional block diagram of a system for using a digital pen according to an illustrative embodiment of the present application.

FIG. 3 is a schematic diagram of a document that is to be authenticated and tracked according to an illustrative embodiment of the present application.

FIG. 4 is a flow chart that illustrates a process that may be performed according to an illustrative embodiment of the present application.

FIG. 5 is a flow chart that illustrates a process that may be performed according to an illustrative embodiment of the present application.

### DETAILED DESCRIPTION

The illustrative embodiments of the present application describe systems and methods for tracking documents and in certain embodiments for authenticating and tracking physical documents through a multiple party work flow across a geographically dispersed area. Prior systems did not provide means for allowing a user (user) to verifying that a particular third party (high school) had indeed complied with a request to provide a physical document (transcript) to a service provider (college) by simultaneously authenticating the third party and document associated with the request, in this case a student's transcript. Prior systems also did not provide means for the student to receive progress data or track the current status of the request and the overall service provider's process (college application admission determination). The systems and methods described provide for authenticating and tracking physical documents through a multiple party work flow.

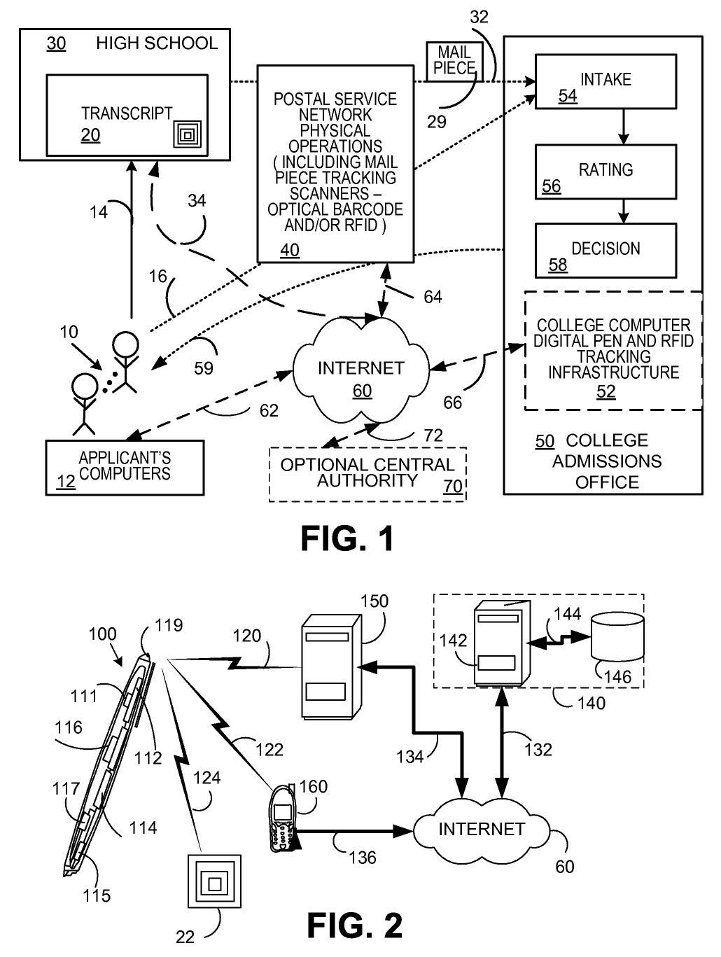

Referring to FIG. 1, a schematic functional block diagram of a system for authenticating and tracking physical documents through a multiple party work flow across a geographically dispersed area according to an illustrative embodiment of the present application is shown. In a typical college application process, a user must poll or pull status updates manually by calling the college (service provider). The systems and methods described herein notify the user when a third party request (transcript request) has been received and processed and when the service provider (college admissions office) has received the requested document and processed it. The systems and methods also facilitate visibility into the internal processing status of the service provider in order to avoid unnecessary status inquiries from the user.

The geographically dispersed systems of FIG. 1 are interconnected electronically using the Internet 70. Additionally, physical communication is accomplished using the United States Postal Service USPS network 40. Alternatively, other electronic networks and physical delivery channels may be utilized. The users of the illustrative system are college applications 10. Each college applicant has access to a computer 12 that is connected to the Internet 60 such as by Internet connection 62. Each user attended a high school 30 and the high school computer system is connected to the Internet 60 using Internet connection 34. The USPS network information systems are connected to the Internet using Internet connection 64. Each college has a college computer 52 connected to the Internet 60 using Internet connection 66. Optional central authority 70 is connected to Internet 60 using Internet connection 72. The Internet connections are utilized to provide messages and electronic files within the network of connected systems.

Each of the actors in the system also has access to the USPS network 40 and some of the connections are described as later referred to in the process flow. User 10 may communicate with high school 30 using multi-purpose channel 14 by using electronic Internet communication, telephonic communication, in person communication and/or mailed physical communication. The user 10 also mails documents to the college admissions office 50 using mail channel 16. The high school 30 uses mail channel 32 to mail the requested document (transcript 20) to the college admissions office 50. The college admissions office 50 uses mail channel 59 to mail documents such as an admission decision to user 10.

The college admissions office 50 includes several departments that separately report events in the work flow process including the intake department 54, the rating department 56 and the decision department 58. Each department is equipped with a distinct digital pen and an RFID reader. The USPS network is equipped with barcode readers, RFID readers and optionally digital pen pattern readers. The high school is equipped with a digital pen and each user is optionally equipped with a digital pen.

Referring to FIG. 2, a schematic functional block diagram of a system for using a digital pen with a document having an RFID tag and a digital paper pattern according to an illustrative embodiment of the present application is shown. Digital Pen 100 includes a processor 114, memory 112, ink 117, a camera or image sensor 115, a battery 116 and a wireless transceiver 111. The pen 100 includes an LED 119. It also includes pen stroke data and biometric sensors (not shown). The pen includes an RFID tag writing subsystem (not shown) that is capable of writing to an active or passive RFID tag adhered to the document. The digital pen 100 is a CHATPEN digital pen available from Anoto, AB and utilizes the corresponding digital pen patterns, but other digital pen systems may be used.

The pen 100 provides biometric data relating to the pen strokes used including hand speed, pen tip pressure and the inclination angle between pen and paper. The pen 100 is also assigned a unique serial number pen. The system includes at least one pen 100 that establishes a personal area network using BLUETOOTH. The paired device may be a router or other processor 150 that connects to the digital pen 100 using wireless connection 120 and provides a gateway using communications connection 134 to the Internet 60. The paired device may include a cellular telephone or PDA 160 that has a Bluetooth connection 122 and a connection 136 to the Internet 60. Here, the system includes a server 140 that includes storage 146 connected by connection 144 to processor 142.

The server 140 is connected to the Internet 60 using communications channel 132. The server may provide digital pen pattern lookup services and may also act as the optional central authority 70 to provide authentication services. For example, authority 70 may maintain necessary keys and pen identification data to provide a standardized document authentication system across multiple parties. Authority 70 may assign unique RFID tag identifiers and unique digital pen pattern spaces so that multiple applicants, high schools and colleges may use the systems without overlapping collisions of identification numbers. Server 140 or processor 150 may be utilized for other digital pen back end activities.

RFID device 22 is a passive RFID tag that is connected to the digital pen 100 using a wireless communications channel. The RFID tag may store an identification number and also authentication data related to the work flow applied to a document. The RFID tag has an associated digital pen pattern printed on the top of the RFID tag and an adhesive on the bottom for adhering it to a document. Alternatively, the RFID tag may be substituted with another wireless storage and/or processing device may be utilized with a communications channel in any appropriate RF band including ultrasound, RF and light. Commonly-owned, co-pending U.S. patent application, Ser. No. 11/513,755, filed on Sep. 30, 2002, by Braun, et al., entitled Method and System for Creating a Document Having Metadata is incorporated herein by reference.

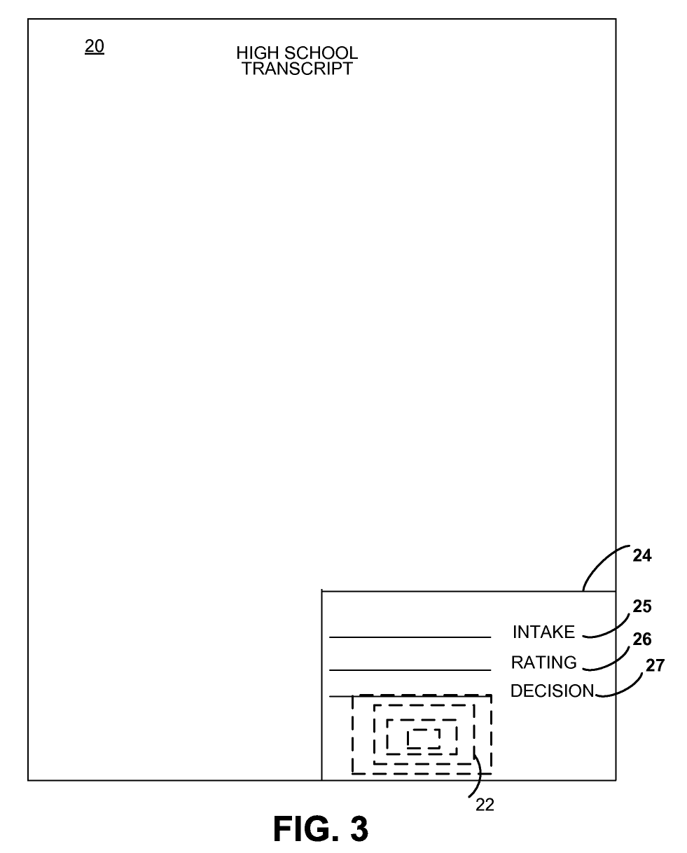

Referring to FIG. 3, a schematic diagram of a document 20 that is to be authenticated and tracked according to an illustrative embodiment of the present application is shown. The RFID tag 22 includes a digital pen pattern on the top of the tag. Here, the RFID tag 22 is shown under a separate digital pen pattern label 24 that is applied by the college admissions intake department 54. Digital pen pattern tag 24 is associated with the RFID tag 22. Digital pen pattern tag 24 includes separate sections to authenticate and report processing events.

The digital pen pattern tag 24 includes an Intake signature line 25 that is signed by a worker in the Intake department 54 to trigger a notification event. The computer 52 provides the intake event notification directly to user 10, but may instead report the event to optional central authority 70. The digital pen pattern tag 24 also includes a Rating signature line 26 that is signed by a worker in the Rating department 56 and a Decision signature line that is signed by a worker in the Decision department 58 to respectively trigger associated notification events to the user 10 or optionally the central authority 70.

Alternatively, digital pen pattern 24 is instead printed on a label originally provides with RFID tag 22. In yet another alternative configuration, the RFID tag is not used, but the physical mail tracking is performed using a PLANET CODE system.

As can be appreciated with review of FIG. 3, such as tag 24 may be similarly applied to other documents related to the application process including reference letters and the application and essay forms completed by the student.

Furthermore, the RFID tag 22 and attached digital pen pattern may be advantageously associated during manufacture of the tag. For example, the physical association of the digital pen pattern being printed or adhered to the RFID tag may also include the digital pen pattern identifier being stored in the memory of the RFID tag device. The digital pen pattern identifier is preferably unique at least across a particular population for at least a period of time. Such an RFID tag may or may not have an associated stored RFID tag identifier. The tag memory may be static, dynamic or a combination of both. The RFID tag may be passive or active and may include a processor. Since there may be two identifiers, one may be a larger number. Furthermore, one of the identifiers may include as a subset, all or a subset of the other identifier. As such, an association may be made using either subset described.

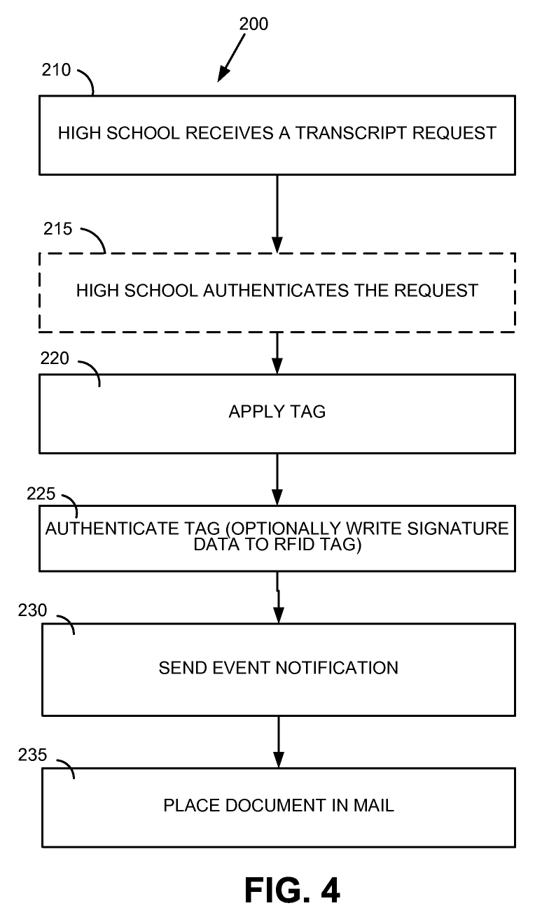

Referring to FIG. 4, a flow chart that illustrates a process 200 that may be performed by a third party (high school) according to an illustrative embodiment of the present application is shown. Generally, a student will make a request to the high school for a transcript to be sent to a college of his/her choice. In step 210 the High school 30 receives a document (transcript) request from the user (student) 10. In step 215, the High School 30 optionally authenticates the request using a digital pen. The authentication, as in all authentication herein, may be accomplishes by receiving authentication pen stroke data associated with the student signing a digital pen patter. The authentication may be receipt of data identifying the digital pen used to check or otherwise mark a digital pen pattern. Such data may be received directly from the student's digital pen through a communications channel, through the student's computer or through a central authority server.

In step 220, the high school 30 applies a non-removable RFID label with a digital pen pattern (ANOTO) and an authentication box. Additionally, the tag may include digital pen pattern related to the down stream work flow process to be performed at the college. Alternatively, the digital pen pattern could be printed directly onto the document without an RFID tag.

In step 225, the authorized high school employee then uses thee digital pen (ANOTO CHATPEN) containing a biometric sensor to authenticate the sender and the transcript by marking information on the patterned label. For example, an authorized signature may be used to authenticate the high school. In step 230, this action also provides an advanced shipment notification event to the intended recipient (college) and other interested third parties, such as the student directly through the Internet 60 or using optional central authority 70.

In step 235, the document (transcript, application, reference) is then placed into the mail stream and tracked using the RFID tag 22 address to the college. Systems for tracking the physical document through the mail stream as described in U.S. Pat. Nos. 6,260,029, 6,275,745, 6,208,910 and 6,701,217 may be utilized for physical tracking purposes. This RFID tracking then continues through the work flow at the facilities of the next party in the process—the college admissions office. The mail stream events may be reported directly to the user 10 from the USPS network 40 if the USPS has been provided such association data for the mail piece and the user 10 or in an alternative in which the mail piece has a notification email address attached. The USPS network may also provide event notices to the high school, college or central authority provided the mail piece is associated with an event notification address such as an email address.

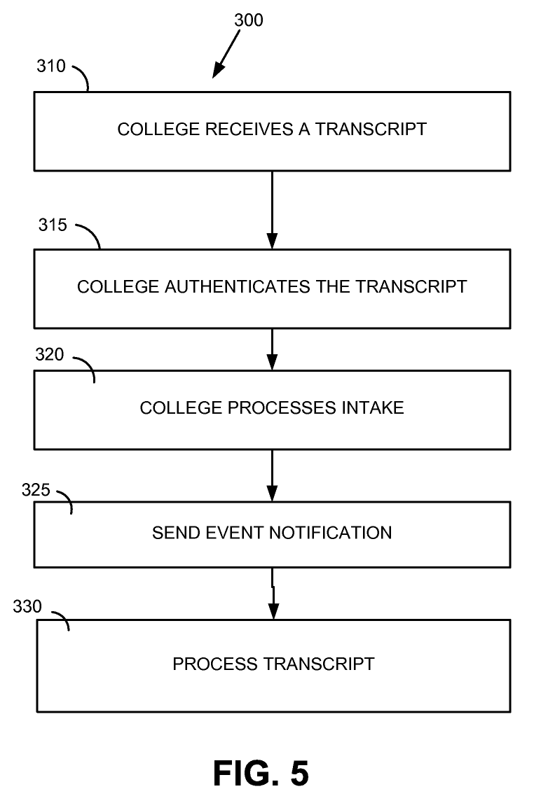

Referring to FIG. 5, a flow chart that illustrates a process 300 that may be performed by a service provider (college) according to an illustrative embodiment of the present application. The mail piece 29 including transcript 20 is ultimately delivered by the USPS network 40 to the intended recipient (college) and in step 310 is received by the admissions office 50. Tracking events will have been reported through the USPS network as described herein using the RFID tag identifier, the digital pen pattern or a code such as the PLANET CODE for tracking purposes.

In step 315, an authorized person opens the mail in the intake department 54 and authenticates the transcript such as by receiving information from the high school such as a digital signature of the ANOTO biometric information or optionally from a central authority. In step 320, the authorized worker performs the intake process and uses a digital pen containing a biometric sensor to acknowledge receipt of the transcript and if not already completed, to further authenticate the sender and the transcript through the system. In step 320, the worker also signs the intake box 25 to authenticate the intake process. At the same time, in step 325 the sender and other interested third parties (student) are notified of receipt and an image of the transcript is emailed to them The image of the transcript is digitally signed and contains the time sent, time received, sent by, received by and other pertinent info.

In step 330, the further processing is represented. As the admissions work process progresses, authorized workers check off appropriate boxes and/or sign the appropriate lines on the digital pen pattern label signifying the start or completion of a particular work stage. Each time a work stage box is checked, interested third parties are again notified and an updated image of the transcript is sent. This updated image of the transcript is again digitally signed and contains the original information plus time next work stage was started and/or completed. Optionally, uncommitted check boxes are also included such that the department processing the work can include new work practice activities initiated after form created.

The systems described herein utilize mechanism for providing confidentiality and data integrity such as cryptographically secured communications channels along with authentication and non-repudiation through Internet browser certificates and the biometric and/or serialized digital pens as described.

In an alternative applicable to any embodiment described herein, the college computer 52 or optional central authority 70 employ a work flow state time tracking process. The college computer 52 then notifies all relevant parties when an expected work flow time exceeds a predetermined boundary.

In an alternative applicable to any embodiment described herein, the student uses digital pen patterned paper to coordinate the parts of a college application including a transcript request, a reference request and the application. The student locally prints digital pen paper for the transcript request, the reference request and the application. The digital pen paper is associated with the particular student and after the three documents related to the application are printed, those particular documents are associated with an application to a particular college using a central authority. Thereafter, the documents can be tracked and status reported as described herein.

The student sends a transcript request to a high school using a transcript request form including digital pen pattern identifying the student. The student optionally signs the request form using a digital pen in order to authenticate the transcript request. The high school then reads the digital pen pattern to identify the student and optionally authenticate the student making the request. The high school then associates the digital pen paper with the new digital pen paper assigned to the transcript (and optionally an RFID tag) so that a cross-link of information is provided at the central authority. Then, as the transcript is processed through the college application process, the central authority may direct status reports to the student.

In an alternative applicable to any embodiment described herein, the central authority 70 is used to “digitally bind” through database associations of identifiers the mail piece, the particular document in the mail piece and the RFID and/or unique digital patterns. The central authority maintains for each user a portfolio of college applications and tracks each separate application including the constituent parts as described herein. Periodically, such as daily or weekly, an aggregate report of activity events for the whole portfolio is electronically sent to the user applicant 10 through Internet 60. Accordingly, digital bindings to each college application are provided to the applicant, participating third parties and the college.

When a document is processed and the related RFID tag is sensed, or the digital pen pattern touched with a digital pen, that event is reported to the central authority and the event report optionally includes a part of the digital pen pattern or another trusted token such that when an Authorized Agent or Entity processes the documents and touches the pattern or retrieves the trusted token, the central authority might display or print an official and authenticated version of the original document for the applicant.

Systems for tracking mail based upon PLANET CODES may alternatively be used to track the transcript and application through the multiple party work flow. Commonly-owned, co-pending U.S. patent application, Ser. No. 11/513,755, filed on Aug. 31, 2006, by Obrea, et al., entitled System and Method for Assembling Complex Document Sets from Geographically Disparate Sources is incorporated herein by reference. In another alternative applicable to any of the illustrative embodiments herein, the systems and methods described therein may be used.

The foregoing illustrative embodiments have been described with reference to a college admission application process. However, the systems and methods described may be applied to many other business processes such as following the status of an insurance claim, filing income taxes and awaiting refund, and tracking applications for various licenses through government agencies including drivers license renewals.

While illustrative embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

We claim:

1. A method for authenticating and tracking documents comprising:
receiving a document request associated with a user;
assigning an authentication and identification tag to a document responsive to the document request; and
authenticating the source of the document using the identification tag.

2. The method according to claim 1, further comprising:
associating the user with the document.

3. The method according to claim 2, further comprising:
receiving data identifying an intended recipient of the document.

4. The method according to claim 3, further comprising:
sending the physical document and tag to the intended recipient using a delivery service.

5. The method according to claim 4, wherein the document delivery service is the U.S. Postal Service.

6. The method according to claim 5, wherein the document includes a tracking identifier.

7. A method for authenticating and tracking documents comprising:
associating a plurality of documents with a completion task; and
tracking whether and to what extent each of said documents progresses through a document processing work flow system by authenticating such progress.

8. The method according to claim 7, wherein:
the completion task is completion of a college admission application; and
the destination is a college admissions office.

9. The method according to claim 7, wherein:
authenticating such progress includes obtaining digital pen data.

10. The method according to claim 7, wherein the completion task is completion of an insurance claim file.

11. A tracking and authentication label comprising:
a wireless tag device including at least one data storage field;
an attached printed digital pen pattern marking; and
an identifier associated with the printed digital pen pattern marking stored in the at least one data storage field.

12. The tracking and authentication label of claim 11, wherein, the at least one data storage field includes a wireless tag identifier field;
an identifier associated with the wireless tag is stored in the wireless tag identifier field and differs from the identifier associated with the printed digital pen pattern.

13. The tracking and authentication label of claim 12, wherein,
the wireless tag identifier field includes a subset of the data in the identifier associated with the printed digital pen pattern.

14. The tracking and authentication label of claim 12, wherein,
the printed digital pen pattern field includes a subset of the data in the identifier associated with wireless tag identifier.
